(19) United States
(12) Patent Application Publication
(10) Pub. No.: US 2008/0320516 A1
(43) Pub. Date: Dec. 25, 2008

(54) TAILORED CHANNEL FOR CONTENT CONSUMPTION

(75) Inventors: Dawson Yee, Bellevue, WA (US); James E. Allard, Seattle, WA (US); David Sebastien Alles, Seattle, WA (US); Nicholas R. Baker, Cupertino, CA (US); Adam T. Berns, Bellevue, WA (US); James C. Finger, Kirkland, WA (US); Todd E. Holmdahl, Redmond, WA (US); Oliver R. Roup, Seattle, WA (US); David H. Sloo, Menlo Park, CA (US); Curtis G. Wong, Medina, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/767,724

(22) Filed: Jun. 25, 2007

(51) Int. Cl. H04N 5/445

(52) U.S. Cl. 725/44

(57) ABSTRACT

The claimed subject matter relates to an architecture that can establish a tailored and/or personalized content channel. The content channel can be interfaced with one or more devices, and can be configured to serve particular content or types of content as well as to filter particular content or types of content. The content can be selected or filtered based upon a wide variety of factors that can be expressly specified, or in some cases intelligently inferred. In addition, the architecture can provide detailed analysis of content and summarize various content consumption habits or histories.

### CROSS-REFERENCE TO RELATED APPLICATIONS

This application is related to co-pending U.S. patent application Ser. No. (MSFTP 1802US) ______ entitled, “NON-MEDIA-CENTRIC PACKAGING OF CONTENT”, which is being filed concurrently. The entirety of this application is incorporated herein by reference.

### BACKGROUND

Historically, the notion of a “channel” such as a television channel or radio station evolved in connection with allocation of scarce broadcast spectrum. Today, given numerous technological advances in data delivery (e.g., new protocols or platforms), infrastructure build-ups (e.g., laying fiber optic cable, launching satellites, or constructing regional towers), as well as a large-scale and widespread migration toward content delivery methods that employ backbones with high bandwidths and/or a surplus of data channels, suggest that one of the original notions of a “channel” based upon limited broadcast spectrum is no longer relevant.

One result is that channels are now generally thought of more as brands that often serve the same or similar content, but package the content differently. For example, American Broadcasting Channel (ABC) and National Broadcasting Channel (NBC) may deliver a news story about the same event, but package the news story in a different way. Likewise, Home Box Office (HBO) and Showtime may both provide the same type of content (e.g., feature films), yet select different content to serve based upon a different set of affiliations with content producers or providers.

Often, well-known “channels” are actually a suite of channels such as ABCSports, ABCFamily, etc., each directed to a particular demographic or audience, but all of them in some way associated with the ABC channel or brand. While many of these channels deign to provide somewhat tailored content, they are still limited by numerous constraints as well as motivated by economic concerns of reaching the maximum potential audience, and thus, the content consumer has no or very little decision-making input. As a result, content consumers have no conventional means for establishing a content channel that provides all of the content he or she desires, yet none of the content he or she does not desire. Moreover, conventional channels typically only provide content in one particular format that is suitable for only one or a small number of similar device types. Accordingly, a content consumer has very few device type options with respect to receiving content from a conventional channel.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can facilitate selection and/or filtering of content in order to, e.g., tailor a content channel. In accordance therewith, content can be selected or filtered based upon specific content, a type of content, a particular device or a type of device suitable for the specified content or content type, as well as based upon a wide range of other factors such as, for example, a date or time to select or filter content. Thus, the content channel can be configured to determine and/or deliver exactly the content that is desired, conceivably at exactly the times in which the content is desired.

In accordance with an aspect, the content channel can be interfaced to one or more devices and can provide a portal or gateway to all or portions of all the content that is delivered by the devices. Thus, a single content channel can service multiple devices, and a single content schedule can be employed to effectuate the rules or settings for content consumption for any or all of the interfaced device, regardless of the type of device or content. Appreciably, the content channel can be beneficially employed in connection with parental controls.

In another aspect, all or portions of content served by the content channel can be monitored and a summary of suitable analysis with respect to the monitoring can be periodically provided to the content manager. The summary can provide, inter alia, flag deviations from the content schedule, provide a total amount of time utilized for content consumption, provide categorical breakdowns or itemizations based upon types of content or types of devices employed to consume content, as well as much additional statistical information associated with content consumption and/or device usage.

It should be appreciated that the content can originate from a variety of sources that can be remote from the content consumer, included in a local library, or be piped in from a disparate content channel. Moreover, in some cases the content can be subscription-based, while in other cases the content can be provided with no associated fees.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a system that can facilitate selection and/or filtering of content in order to tailor a content channel.

FIG. 2 illustrates a block diagram of a system that can facilitate content delivery to a device.

FIG. 3 depicts a graphical representation of a portion of an example content schedule.

FIG. 4 illustrates a block diagram of a system that can provide for examination and/or feedback in relation to the content channel.

FIG. 5 is a block diagram of a system that can provide presence information in connection with content.

FIG. 6 depicts an exemplary flow chart of procedures that define a method for facilitating tailoring of a content channel based upon selection or filtering of content.

FIG. 7 is an exemplary flow chart of procedures that define a method for obtaining, selecting, filtering, or serving content.

FIG. 8 illustrates an exemplary flow chart of procedures that define a method for monitoring and/or summarizing information related to content served by a content channel.

FIG. 9 illustrates a block diagram of a computer operable to execute the disclosed architecture.

FIG. 10 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect, feature, embodiment, or design described herein as “exemplary” is not necessarily to be construed as preferred or advantageous over other. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

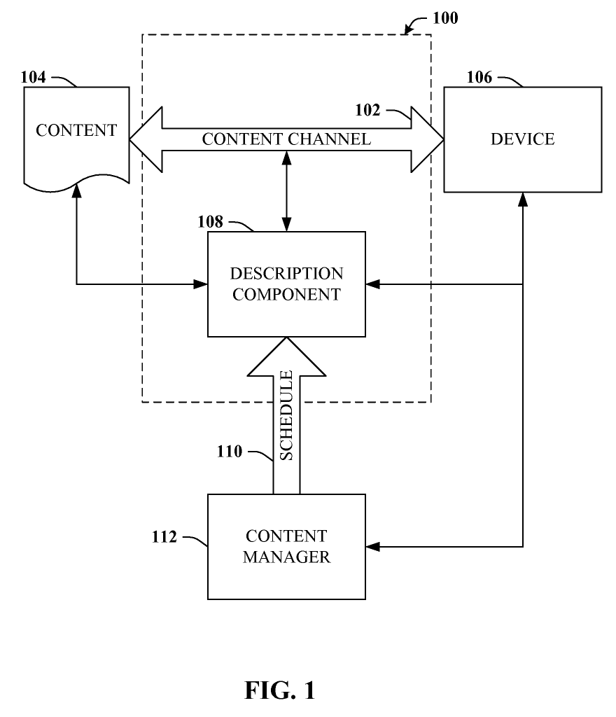

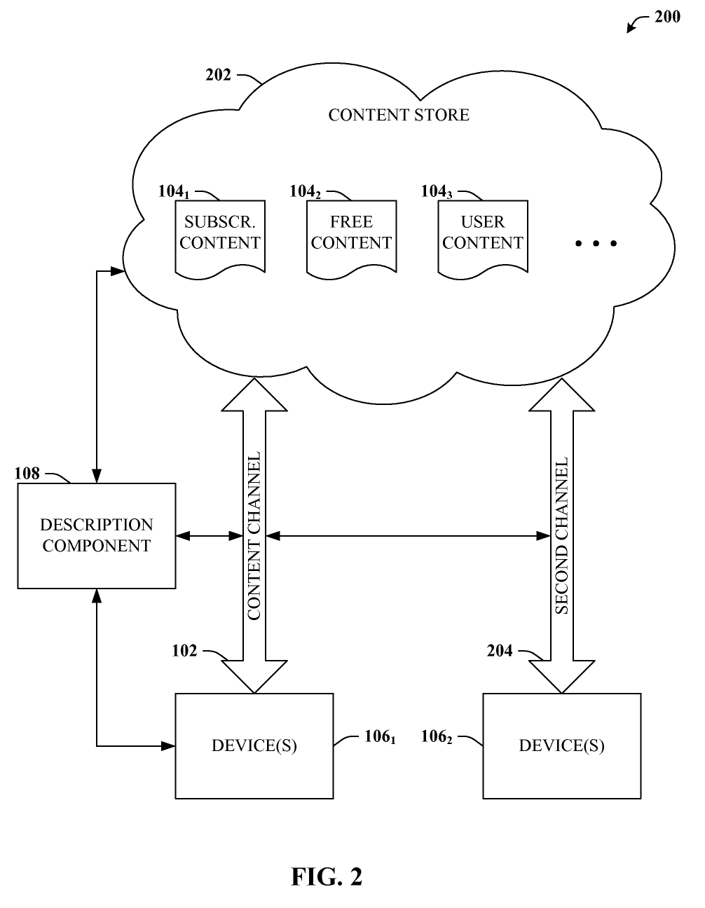

Referring now to the drawings, with reference initially to FIG. 1, a system 100 that can facilitate selection and/or filtering of content in order to tailor a content channel is depicted. Generally, the system 100 can include a content channel 102 that can serve content 104 to an interfaced device 106. The content channel 102 is typically a channel associated with and/or defined or configured by a single family or household. The content 104 can be entertainment-based or educational/informative content including but not limited to movies, television programs, games, web content, literature, instructional or learning content. The content 104 can also include advertisement-based content 104 such as commercials or advertisement. Additional description related to content 104 can be found infra in connection with FIG. 2.

The device 106 can be substantially any electronic or controller-based I/O device that can be employed to deliver content 104. A common type of device 106 can be, e.g., a television or associated peripherals or devices dependent upon the television such as a Digital Versatile Disc (DVD) player, a game console, or a media center. In accordance with an aspect, the device 106 can also be a personal computer (e.g., desktop, laptop, tablet, mobile, handheld, wearable . . . ), stereo or media player/recorder (either hardware or software), a cellular or smart phone, a handheld game console, and so on.

It is to be appreciated that the content channel 102 can be simultaneously or sequentially interfaced to a plurality of devices 106 and, as such, the content channel 102 can serve content 104 to multiple devices (e.g., serve content 104 to a television in a bedroom as well as a television in another room) as well as to multiple device types (e.g., serve content 104 in one case to a television and in another case to a desktop computer). In accordance therewith, it is readily apparent that content channel 102 is not necessarily limited to a single format for the content 104. Rather, given the potential for a single content channel 102 to serve a variety of different types of device 106, the content channel 102 can propagate many different content formats. Hence, while conventional “channels” are associated with a particular broadcast spectrum, or exist as data channels configured for a very specific device type or a very specific content format, the content channel 102 is not necessarily so limited.

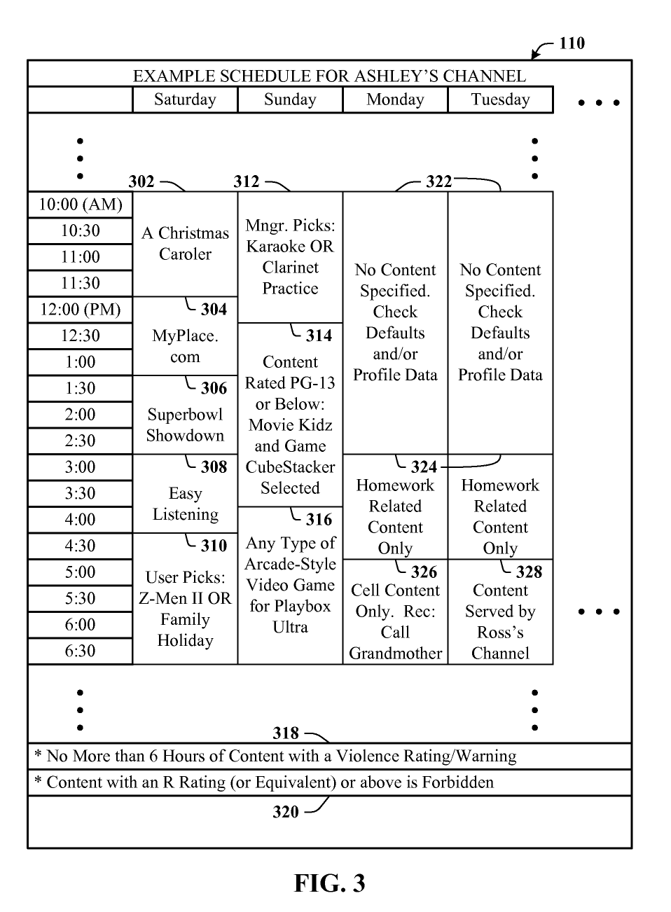

The system 100 can also include a description component 108 that can receive a content schedule 1 10. Further details relating to the content schedule 110 are set forth in FIG. 3, however, as an initial introduction, the content schedule 110 can be employed by the description component 108 to configure the content channel 102 and/or particular content 104 that is served by the content channel 102 as well as types of content 104 that can be served by the content channel 102. The content schedule 110 is typically supplied by the content manager 112, which can be an owner, maintainer, administrator, rights holder, etc. of the content channel 102. The content manager 112 can also be an owner or possessor of the device 106

In accordance with one aspect of the claimed subject matter, the content schedule 110 can specify the content 104 that is served in connection with one or more time periods. Hence, the content schedule 110 can include blocks of time for which particular content 104 can be accessed by way of the content channel 102. It is to be appreciated, however, that serving the content 104 need not be limited by time constraints. Rather, in some situations, the content channel 102 can act as a portal to designated content 104, portions of which can be served at any time and in any sequence, potentially based upon a decision by a content consumer or based upon a variety of other factors.

According to an aspect, the content schedule 110 can specify a first portion of content 104 and a second portion of content 104 in the alternative, as well as a criterion utilized to select between the first and second portions. For example, two or more movies or games (e.g., respective portions of content 104) can be specified in the alternative by the content schedule 110 along with the criterion for selecting which of the two or more portions of content 104 will be served. In addition, the content schedule 110 can include an indication of why the portions of content 104 are specified in the alternative.

One reason may be due to time constraints, another reason may be due to budgeting, while a third rationale may be reliant upon limiting exposure to certain genres or categories of content 104. In particular, in a two hour period a content consumer can normally watch only one movie due to time constraints. Likewise, for fee-based content 104, a content consumer allocated a certain amount of credit or currency may only be able to purchase one portion of the content 104 due to budgeting constraints. Furthermore, limiting exposure to, say, violence can result in a constraint that either a crime drama movie or a first-person shooter game can be served, but not both. It is to be appreciated that the indication for why portions of content 104 are specified in the alternative can be useful for determining later accessibility for both the selected content 104 and the non-selected content 104. It should also be appreciated that such indication need not be expressly included in the content schedule 110, but, rather, in some cases, can be determined or inferred.

The criterion utilized to select between the first and second portions of the content can be as straightforward as a selection by the content manager 112 or other content consumer. Thus, the content consumer of content channel 102 can choose between the alternative content 104. However, the criterion can be based upon other factors as well such as prior choices or selections, prior content 104 consumption, an identity of the content consumer, and so on.

In accordance with the foregoing, it is readily apparent, yet for the sake of thoroughness, it should be underscored that the content 104 can be served to many different devices 106 and/or device 106 types. Accordingly, the first portion of the alternatively specified content can be served to a first device 106 or the second portion of the content can be served to a second device 106. Moreover, the content schedule 110 can specify a type of device 106 to which content can be served rather than specifying the content 104. Thus, for example, the content schedule 110 specify that a television should be served content during a certain period of time. Accordingly, content 104 suitable for a televisions can be selected by the content manager 112, by another consumer of content, or by the description component, based upon various inferences that are described in more detail infra.

Additionally, in accordance with an aspect of the claimed subject matter, the content schedule 110 can specify a type of content that is forbidden to be served by the content channel 102. Thus, in addition or in the alternative to selecting content 104, the description component 108 can also filter content as well. It is to be further appreciated that in accordance with another aspect, the device 106 can be configured such that the only source of content is the content channel 102 and/or that all I/O to the device 106 must conform to settings associated with the content channel 102. In such a case, forbidding a type of content can effectively prevent that type of content from being propagated from any device(s) 106.

Turning now to FIG. 2, a system 200 that facilitates content delivery to a device is illustrated. In general, the system can include the description component 108 that can configure the content channel 102 in accordance with the content schedule (e.g. content schedule 110 of FIG. 1). The content 104 can be obtained from a content store 202 that can be a centralized or distributed storage cloud accessible by way of any suitable platform, architecture, or protocol. Additionally or alternatively, all or portions of the content store 202 can be comprised of a local library that can be electronically stored or encoded in readable media such as a DVD, CD, cassette tape, etc.

As described above, the content 104 can exist in a wide range of formats suitable for many types of devices. Moreover, as depicted, the content 104 can be classified in various ways. As one example, that content 104 can be subscription-based content 104₁ for which there is a fee for obtaining the content 104₁. Examples include movies, music, games, or other exclusive content 104₁ that can be offered by commercial entities or organizations such as studios, recording labels, or developers. On the other hand, much of the content 104 can be free content 104₂, including much of the content 1042 on the web, content 104₂ under a General Public License (GPL), or ceded to the public domain, freeware, shareware, or substantially any content 104₂ that can be obtained at no initial cost. As a third example, the content 104 can be user-created content 104₃, which can be content 1043 that is created by or for the device manager 112. Content 104₃ can be characterized as subscription-based content 104₁ or free content 104₂.

Of course other types of classifications for content 104 can exist, yet regardless of how the content 104 is classified, it is to be understood that substantially any content 104 in the content store 202 can be delivered to the device(s) 106₁. However, in accordance with an aspect of the claimed subject matter, content 104 can also be obtained from a second configurable content channel 204. The second content channel 204 can be operatively coupled to the content store 202 and device(s) 106₂ in a manner similar to content channel 102, as depicted in FIG. 2, but it is also to be understood that the second content channel 204 can be coupled to a disparate content store (not shown) potentially including a different set of content 104. Hence, while the description component 108 can facilitate selection of content 104 (based upon inference and/or information associated with the content schedule 110) for the content channel 102, the selected content 104 need not be included in the content store 202, As well, the content (even if included in the content store 202) need not be directly selected by the description component 108, but in fact can be, e.g., selected for the second channel 204 by a disparate component (not shown) similar to the description component 108, and piped into the content channel 102 from the second channel 204.

In addition, it is to be appreciated and understood that, as described in connection with FIG. 1, the description component 108 can provide for numerous inferences relating to content selection or filtering. For example, while a common situation exists in which the content schedule 110 expressly indicates the exact content 104 to serve, other situations exist in which the exact content 104 is not specified. Thus, in the latter situation, the description component 108 can dynamically and/or intelligently choose the content 104 to be served. For example, when the content schedule 110 specifies a time to serve content 104, a type of content 104 to serve, a type of device 106₁ in which to serve the content 104, etc., but does not expressly indicate certain content 104, then the actual content 104 selected may need to be intelligently determined. Likewise, when certain content is forbidden to be served by the content channel 102, it may be necessary to intelligently determine or infer what content within the content store 202 need by filtered.

For aspects relating to intelligently selecting content 104, data sets indicative of the following can be employed: a history of content consumption on the content channel 102; a history of explicit selections, preferences or guidelines set forth by the content manager 112; demographics relating to the content manager 112 or to a designated primary content consumer for the content channel 102; associations or relationships with other content managers 112; an identity of a current content consumer; as well as other data sets described herein, or that those that are otherwise appropriate.

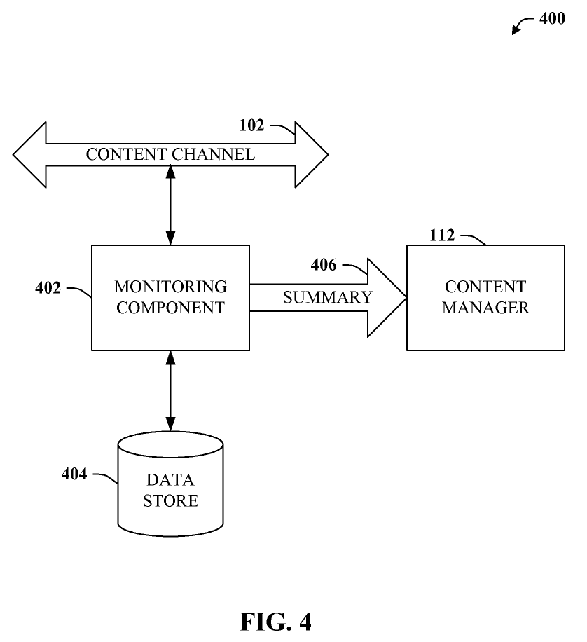

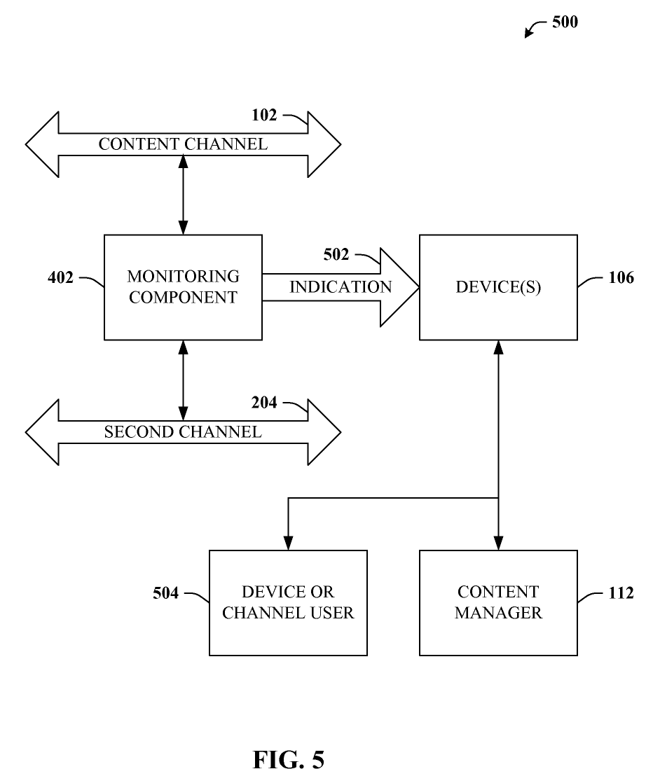

For aspects relating to intelligently filtering content 104, all or a subset of the data sets described above can be employed. In addition, the content 104 itself can be examined (e.g., by a monitoring component further detailed with respect to FIGS. 4 and 5) for certain features extent in, e.g., metadata, keywords, or visual indicia that can be suggestive of violence, vulgarity, nudity, and so on. Furthermore, data sets indicative of content ratings or warnings, generally maintained by industry associations related to one or more respective types of content 104, are very common and can be employed as well. As one example, the Motion Picture Association of America (MPAA) and an affiliate organization PauseParentPlay maintain comprehensive data relating to content 104 classification, ratings, and warnings, which can be obtained by way of the Internet at www dot mpaa dot org and www dot pauseparentplay dot org, respectively. Industries relating to gaming, literature, as well as other types of content 104, host similar associations or organizations that provide similar data for their own respective industry, any or all of which can be employed to aid in intelligently selecting or filtering content 104.

Thus, in order to make a determination related to selection or filtering, the description component 108 can examine the entirety or a subset of the data available and can provide for reasoning about or infer states of the system, environment, and/or user from a set of observations as captured via events and/or data. An inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

Referring to FIG. 3, a graphical representation of a portion of an example content schedule 300 is provided. It is to be appreciated that the example content schedule 300 depicted by FIG. 3 is primarily intended to be illustrative, but is not intended to limit the claimed subject matter to just the described or delineated aspects. In particular, the format of the example content schedule 300 need not be suitable for all content schedules (e.g. content schedule 110 of FIG. 1) that are applicable to the appended claims. For example, the depicted content schedule 300 is largely ordered based upon dates and times, which while potentially more suitably structured for some applications may not be required or desired for others. Rather, in other applications a content schedule 110 can define or describe content to be served by a content channel based upon other factors such as when a device is activated, strict sequential and/or repeating content, or other potentially external factors.

However, the content schedule 300 provides one concrete example of many aspects of the claimed subject matter, which can be better understood in connection with the following scenario and by referring again to FIG. 1 in addition to FIG. 3. Debbie (e.g., content manager 1 12), a conscientious parent, wants to take a more active role in the types of content her daughter, Ashley (e.g., a primary content consumer), is exposed to. However, due to the magnitude of available content that exists today as well as the ease with which such content can be accessed, such a role is arguably more difficult than at any previous time. There are many organizations or conventional mechanisms that cater to parental controls, but these are often only directed to a single type of content or are packaged to appeal to the maximum amount of people. No conventional organization or mechanism allows Debbie to tailor a content channel for all the content 104 she wants and none of the content she does not.

Thus, Debbie decides to manage the content channel 102, which she appropriately names “Ashley's channel”, as it is intended to be Ashley's primary source for audio/visual material. It is to be appreciated that the content manager can establish multiple content channels 102, to facilitate further personalization based upon a wide range of factors. For example, content channels 102 can be established based upon devices 106 (e.g. Ashley's TV Channel, Ashley's Gaming Channel, . . . ), as well as based upon external conditions such as tailoring a content channel expressly for weekends, holidays, or even for misbehavior (e.g. Ashley is Grounded Channel).

Continuing with the scenario, Debbie interfaces the content channel 102 with a variety of Ashley's devices 106 and submits the content schedule 300 to the description component 108. In one aspect of the claimed subject matter, the content schedule 300 can specify the content 104 that can be served to the device 106 in accordance with one or more time periods. In accordance therewith, content schedule 300 illustrates reference numerals 302-306 that specify particular content in accordance with particular time periods. In particular, reference numeral 302 relates to a movie that Debbie enjoyed in her childhood entitled, The Christmas Caroler; reference numeral 304 relates to web-based content at the widely popular MyPlace.com website, in which Ashley enjoys maintainer her profile and a blog of the events in her daily life; and reference numeral 306 relates to Ashley's favorite sports-type video game, Superbowl Showdown.

It is to be appreciated that for each reference numeral 302-306, a different device 106 can potentially be employed in each case respectively. For instance the content channel 102 can serve the movie to a television for reference numeral 302, serve the web content to a computer (or components thereof, e.g., a web browser) for reference numeral 304, and serve the video game to a gaming console for reference numeral 306. It is to be appreciated that the actual content 104 in each case can exist locally (e.g., a DVD or VHS tape of “The Christmas Caroler” or a DVD, CD, game cartridge, or software application of “Superbowl Showdown”) or can exist in a remote data store or cloud, potentially electronically delivered based upon a subscription or fee.

In accordance with another aspect of the claimed subject matter, the content schedule 300 can specify in the alternative a first and a second content for a time period and further specify a criterion that can be utilized to select between the first and second content. Reference numeral 310 illustrates such as case in which an action movie, “Z-Men II” or a comedy movie, “Family Holiday” can be selected for viewing between the hours of 4:30 pm and 7:00 pm on Saturday. The criterion in this case is illustrated by “User Picks:”, indicating that the current content consumer (e.g., Ashley) is provided the option of choosing which movie she would prefer to watch during that time.

Reference numeral 312 illustrates a similar situation, however in this case, the criterion indicates that the content manager 112 should make the selection. Accordingly, the selection can require a passcode or some other means for identification/verification that the selection is made by the content manager 112. It is to be understood that other criterion can be employed. For example, the criterion could indicate that the selection should be randomized or selected by certain entities or based upon certain conditions. A second distinction between reference numerals 310 and 312 is that the alternative content is of a different type and to be delivered to a different device 106 depending upon the selection. For instance if Karaoke is selected, suitable content 104 can be delivered to an entertainment center, whereas if Clarinet Practice is selected, sheet music, e.g. can be served to a tablet PC.

The content schedule 300 can also specify a type of content that is to be served within a time period. Additionally or alternatively, the content schedule 300 can specify a type of device 106 that can be served. In addition, the description component 108 can determine the actual content 104 that is served based upon the type of content indicated. These features are illustrated by reference numerals 314 and 316. At reference numeral 314, the type of content is in this case content 104 that is rated PG-13 or below. Potentially based upon machine learning techniques and/or other inference based determinations described supra, the description component 108 selected a movie entitled “Kidz” and the game “CubeStacker”, both of which are rated at or below PG-13 (or a suitable equivalent). Reference numeral 316 depicts the situation in which both a type of content is specified (here any type of arcade-style video game) as well as a particular device 106 (here the Playbox Ultra Console). Consistent with these definitions the description component 108 can select suitable content 104.

In accordance with another aspect of the claimed subject matter, the content schedule 300 can specify a total amount of time within a time period in which a type of content can be served. Reference numeral 318 depicts an exemplary illustration of such a feature. Here, it is specified that no more than 6 hours of content with a violence rating/warning can be served per week. It should be understood that other types of restrictions can be made such as, e.g. restricting a total amount of time in which a type of device can be employed or similar. Such a content or device limitations can affect a later content selection, a criterion related to a selection, as well as determinations performed by the description component 108.

In another aspect, the content schedule 300 can specify a type of content (or a type of device, etc.) that is forbidden to be served by the content channel 102. Reference numeral 320 provides one example of such a feature, indicating that content rated “R” (or an equivalent depending upon the rating source and/or the type of content 104) or above is forbidden.

Reference numerals 322-328 illustrate additional features that can be included in conjunction with the claimed subject matter. At 322, no content is specified before 3:00 pm since Ashley is usually at school until that time. During these times, defaults, profile data, as well as inferences on the part of the description component 108 can be employed with respect to serving content. For example, a default could indicate that in the event a device 106 is activated, no content will be served. In the alternative, specifying no content 322 can be intended to mean that Ashley has full autonomy to select any content in connection with any device 106, or substantially anything between the above extremes. It is to be appreciated that the description component 108 can also allow content 104 in an ad hoc manner.

For instance, assuming that no content is allowed, because Debbie knows that Ashley will be at school where she will not be using any of the devices 106. However, while at school, Ashley becomes ill and wants to use her cell phone (which is interfaced to the content channel 102) to call her mom at work. In such a case, the description component 108 can intelligently override any directives included in the content schedule 102, and allow the call. In other aspects, the device 106 can transmit a request to override a content setting or otherwise enable or activate content 104, the content channel 102, and/or the device 106. For example, a “panic button” can be employed that removes any restrictions on a device's 106 functionality for, say, 30 minutes. As another example, the description component 108 can query Ashley as to the relevance and/or necessity of the use, and accept the reply on its face. In all of these cases, regardless of the actions taken or the reasons, all relevant information can be delivered to the content manager 112 in the form of a summary which can be examined to determine whether deviating from the content schedule 300 was in fact, necessary and/or germane. The summary is described in more detail in connection with FIG. 4.

At reference numeral 324, Debbie again chooses to limit the content channel 102 to a particular type of content. After school, Ashley's activities with respect to the devices 106 are limited to homework-related content. Debbie realizes that she may not know in advance precisely what “homework-related” entails because it may apply to web surfing for a research paper, watching a film for theater class, as well as to more traditional forms of homework. Thus, she leaves the decision-making for access to content 104 up to the description component 108, understanding that she need not micromanage the content schedule 300 and can always review a summary at a later time that indicates what content 104 was served during the “homework only” time periods.

Reference numeral 326 illustrates a case in which the content schedule 300 specifies a type of device that can be employed during a time period. Here, the device 106 is Ashley's cell phone is the specified device, indicating that if, during this time, Ashley turns on her GameGirl, a handheld gaming console, content may not be accessible. In addition, at reference numeral 326, the content schedule 300 also features a recommendation, that Ashley call her grandmother, because Monday is her grandmother's birthday. The recommendation can be delivered to the device 106 in order to facilitate additional features, such as to serve as a reminder, to automatically configure the cell phone with a phone number, or any number of other suitable features.

Lastly, at reference numeral 328, Debbie decides to add to the mix of her own scheduling ideas with those of others. Thus, she decides that between 5:00 pm and 7:00 on Tuesday, Ashley can be delivered any content that is available to her neighbor and best friend, Ross. Like Ashley, Ross has his own content channel 102 that is managed by one of his parents, who Debbie knows is also conscientious about Ross's exposure to media, Debbie trusts the content for Ross's channel will be appropriate for Ashley.

It should be understood that while the above scenario is provided in the context of parental controls, other situations are contemplated to exist. For example, Debbie can also create one or more content channels 102 for herself, e.g. designed to help organize her tasks at home or work, simply to gain a better understanding of her own content consumption habits, or for many additional reasons.

With reference now to FIG. 4, a system 400 that can provide for examination and/or feedback in relation to the content channel 102 is depicted. Generally, the system 400 can include the content channel 102 that serves content to a device. In addition, the system 400 can include a monitoring component 402 that can monitor or record statistics associated with the content that is served by the content channel 102. The monitoring component 402 can also monitor or record other statistics such as those related to input to the device, transactions with content or service or content providers, deviations from the content schedule, and so forth. The monitoring component 402 can aggregate and/or store the statistics to a data store 404.

In accordance with an aspect of the claimed subject matter, the monitoring component 402 can periodically provide to the content manager 112 a summary 406 of the statistics monitored or recorded. For example, the monitoring component 402 can generate the summary 406 from the statistics stored in the data store 404, e.g. once per week. In accordance therewith, even if the content manager 112 puts few or no constraints upon the content consumption (e.g., by way of the content schedule), she can still be apprised of information associated with the particular content consumed, the types of content consumed, an amount of various content or types of content consumed, device or device type usage, criterion-based selections of content, effects of incentives or recommendations, as well as a host of other information.

Turning now to FIG. 5, a system 500 that can provide presence information in connection with content is illustrated. The system 500 can typically include the monitoring component 402 that can actively monitor or record transactions associated with the content channel 102 as described herein. Additionally, the monitoring component 402 can interface with a second content channel 204 in order to provide an indication 502 of content that is served or scheduled to be served by the second content channel 204.

For example, returning to the scenario introduced above, assume that Debbie and Ashley are enjoying a quiet evening at home and collectively decide to watch television together, yet neither one can decide what content should be selected. Thus, Debbie and Ashley decide to check Ross's channel (e.g., the second channel 204) to get content ideas for themselves. As another example, consider the case in which Ashley simply wants to know what her best friend, Ross, is doing right now. She makes a suitable request and learns that Ross is playing Superbowl Showdown, one of Ashley's favorite games. Ashley quickly logs onto her own account of the same game and challenges Ross to a game.

The indication 502 can be delivered to any of the devices 106 as well as to an interface associated with the monitoring component 402 and/or the description component 108 of FIG. 1. Thus, in the first example above, the indication 502 of content on Ross's channel can be provided to the television that Debbie (content manager 112) and Ashley (device/channel user 504) are utilizing, whereas in the second example, the indication 502 that Ross is playing a sports game can be output directly to Ashley by way of the monitoring component interface. It is to be further appreciated that numerous issues of trust and privileges are potentially involved with regard to the indication 502. Accordingly, before Debbie or Ashley can receive the indication 502, Ross (or a second content manager 112) may be required to agree and/or set appropriate permissions.

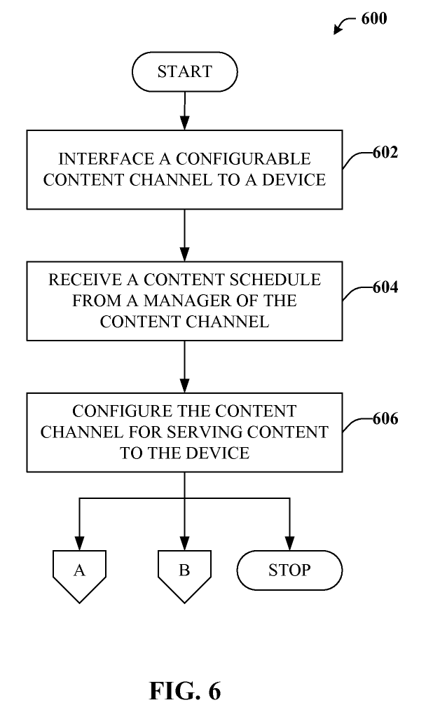

FIGS. 6, 7, and 8 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 6, an exemplary method 600 for facilitating tailoring of a content channel based upon selection or filtering of content is depicted. At reference numeral 602, a configurable content channel can be interfaced to a device. It is to be appreciated that a single content channel can be interfaced to numerous devices, and, likewise, a single device can be interfaced to multiple content channels. Furthermore, a device interfaced to a content channel can be in some cases only transactions that are propagated by way of the one or more interfaced content channels. For example, a cell phone (e.g., interfaced device) can be configured to receive web content only by way of the content channel but can perform other functions such as making outgoing calls as would normally be available. In other cases, however, all transactions may be provided by way of the content channel, and therefore may be subject to various requirements or conditions before certain features or functionality can be utilized.

At reference numeral 604, a content schedule can be received from a manager of the content channel. The content schedule can specify a wide range of information such as suitable content, appropriate times for certain content, as well as types of content that should be selected or filtered and/or types of devices that should or should not be utilized. At reference numeral 606, the content channel can be configured for serving content to the device in accordance with the content schedule.

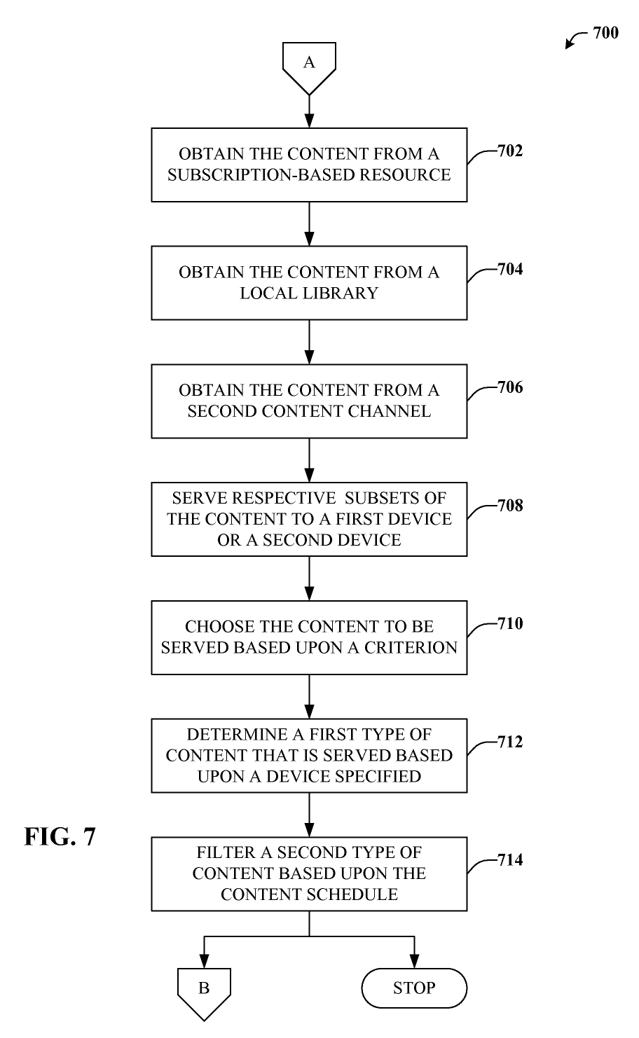

Referring to FIG. 7, a method 700 for obtaining, selecting, filtering, or serving content is provided. Generally, reference numerals 702-706 pertain to obtaining the content from a variety of suitable resources. At reference numeral 702, the content can be obtained from a subscription-based resource, wherein the content can be provided in exchange for a purchase price, usage fee, or the like. At reference numeral 704, the content can be obtained from a local library. For instance, the content schedule may provide that a particular movie, a DVD copy of which is owned and locally available, can be selected for viewing. According to an aspect of the claimed subject matter, it is to be appreciated that in some situations even locally available content may not be accessible to one or more suitable device such as when the content or type of content is forbidden or restricted for a period of time. At reference numeral 706, the content can be obtained from a second (e.g., disparate or remote) content channel. For example, the second content channel established by another content manager can, in some cases, be utilized to obtain content for the content channel.

At reference numeral 708, a first subset (e.g., a movie) of the content can be served to a first device (e.g., a television) or a second subset (e.g., a video game) can be served to a second device (e.g. a gaming console). Thus, it is to be appreciated that different types of content can be selectively served by the content channel as can many distinct devices or device types. At reference numeral 710, the content to be served by the content channel can be selected or chosen based upon a criterion. For example, at act 708, whether the first subset or the second subset is served can be based upon the criterion, which can be a selection by the content manager, a selection by the content consumer, a dynamic and/or intelligent selection related to an inference, or even based upon an active device or device type.

At reference numeral 712, a first type of content can be determined based upon the device specified by the content schedule. For example, if the content schedule specifies that a particular device should be served by the content channel, then the type of content can be determined based upon suitability for the specified device. At reference numeral 714, a second type of content can be filtered based upon the content schedule. One example situation is the case where the content schedule specifies that no content that contains an R-rating or a violence or vulgarity warning should be served. Another example situation is the case in which a content consumer does not agree with the conclusions, objectives, or procedures of a particular entity, hence all content from that entity can be filtered.

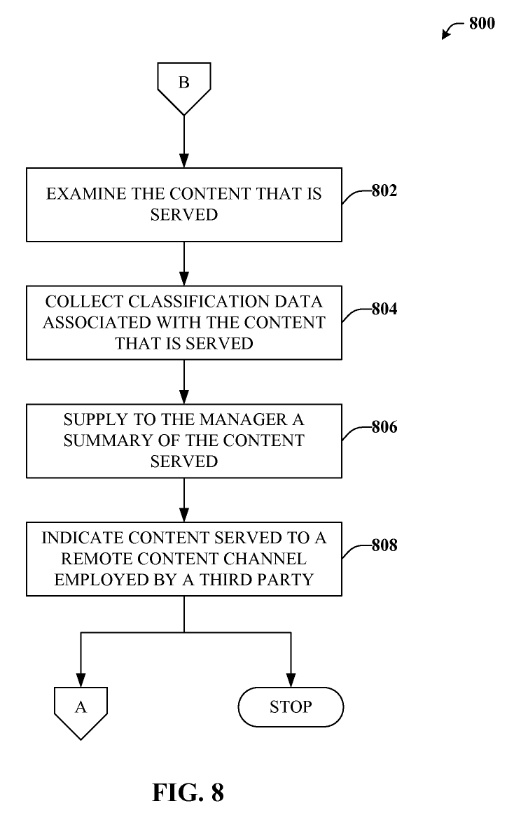

Turning now to FIG. 8, a method 800 for monitoring and/or summarizing information related to content served by a content channel is illustrated. In general, at reference numeral 802, the content that is served by the content channel can be examined or monitored. Such activity can include monitoring various statistics related to the types of content or transactions related to the content as well as a scan of keywords, metadata, or visual depictions. At reference numeral 804, classification data associated with the content that is served, such as classification data obtained at act 802, can be collected. For example, the data can be stored to a data store.

At reference numeral 806, a summary of the content that is served by the content channel can be supplied to the content manager, e.g., on a periodic basis. The summary can further include statistics or classification data collected at acts 802 and 804, respectively. At reference numeral 808, content served or scheduled to be served by a remote content channel can be indicated to the content manager or content consumer of the (local) content channel. It is to be appreciated that the remote content channel can be a content channel employed by a third party such as a friend or neighbor.

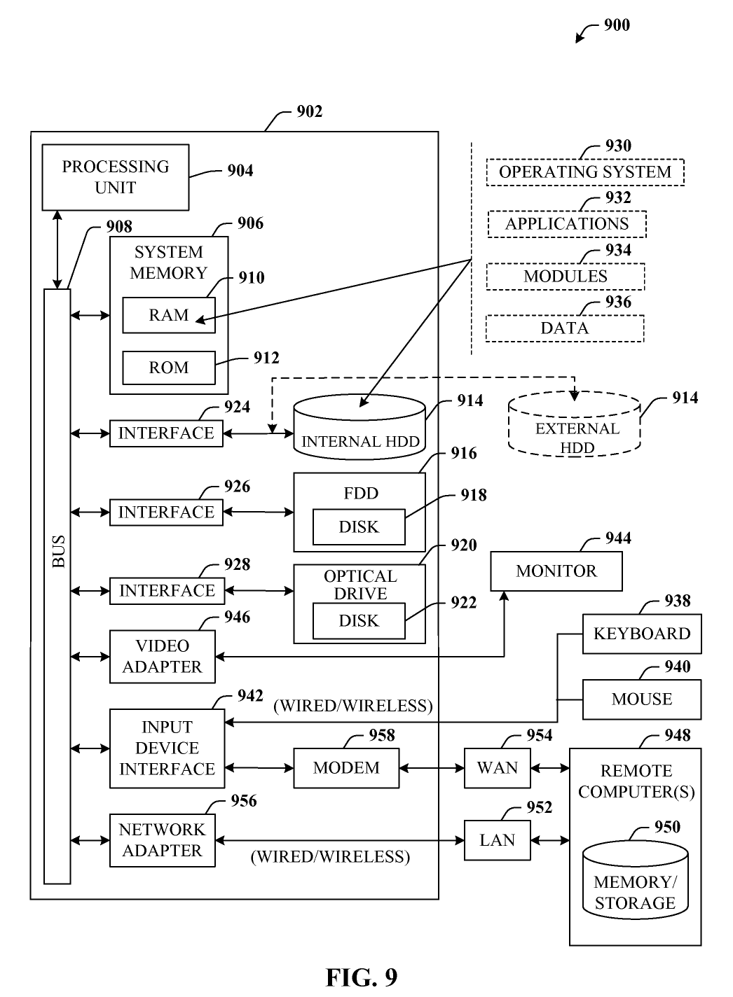

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above can be implemented in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the claimed subject matter.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 9 Mbps (802.11a) or 54 Mbps (802.11b) data rate, for example, or with products that contain both bands (dual band), so the networks can provide real-world performance similar to the basic 9BaseT wired Ethernet networks used in many offices.

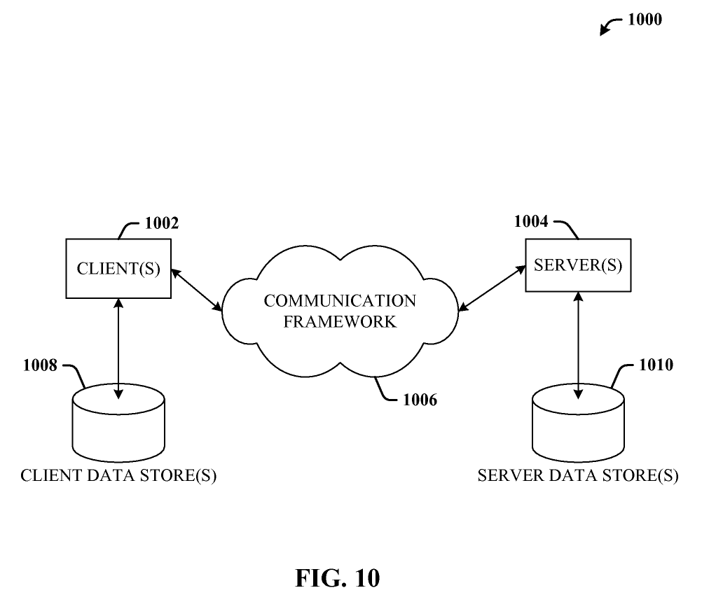

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates selection and/or filtering of content in order to tailor a content channel, comprising:
a configurable content channel that serves content to a device; and
a description component that receives a content schedule from a manager of the content channel, and configures the content channel in accordance with the content schedule.

2. The system of claim 1, the device is at least one of a television, a gaming console, a computer, a media player, or a phone.

3. The system of claim 1, the content or a portion of the content is subscription-based.

4. The system of claim 1, the content or a portion of the content is created by the manager.

5. The system of claim 1, the content or a portion of the content is an output from a second configurable content channel.

6. The system of claim 1, the content schedule specifies the content that is served in accordance with one or more time periods.

7. The system of claim 1, the content schedule specifies in the alternative a first and a second content, and further specifies a criterion that is utilized to select, from among the first and the second content, the content that is served.

8. The system of claim 7, the first content is served to a first device or the second content is served to a second device.

9. The system of claim 1, the content schedule specifies a type of content that is served, and the description component determines the content that is served based at least in part upon the type of content specified.

10. The system of claim 1, the content schedule specifies a total amount of time within a time period in which a type of content can be served.

11. The system of claim 1, the content schedule specifies a type of device that is served content.

12. The system of claim 1, the content schedule specifies a type of content that is forbidden to be served by the content channel.

13. The system of claim 1, the device is configured to output only content that is served by the content channel.

14. The system of claim 1, further comprising a monitoring component that monitors or records statistics associated with the content that is served by the content channel.

15. The system of claim 14, the monitoring component provides to the manager a summary of the statistics.

16. The system of claim 14, the monitoring component provides an indication of content served by or scheduled for a second content channel.

17. A method for facilitating tailoring of a content channel based upon selection or filtering of content, comprising:
interfacing a configurable content channel to a device;
receiving a content schedule from a manager of the content channel; and
configuring the content channel for serving content to the device in accordance with the content schedule.

18. The method of claim 17, further comprising at least one of the following acts:
obtaining the content from a subscription-based resource;
obtaining the content from a local library;
obtaining the content from a second content channel;
serving a first subset of the content to a first device or a second subset of the content to a second device;
choosing the content to be served between a third subset of the content and a fourth subset of the content based upon a criterion;
determining a first type of content that is served based upon the device specified by the content schedule; or filtering a second type of content based upon the content schedule;

19. The method of claim 17, further comprising at least one of the following acts:
examining the content that is served;
collecting classification data associated with the content that is served;
supplying to the manager a summary of the content served based upon the classification data; or
indicating content served to a remote content channel employed by a third party.

20. A system for selecting or filtering content to provide a tailored content channel, comprising:
means for coupling a configurable content channel to a device;
means for obtaining a content schedule from a manager of the content channel;
means for defining the content channel for serving content in accordance with the content schedule; and
means for delivering the content to the device by way of the content channel.
